(19) United States
(12) Patent Application Publication
(10) Pub. No.: US 2013/0131897 A1
(43) Pub. Date: May 23, 2013

(54) THREE DIMENSIONAL AUDITORY REPORTING OF UNUSUAL AIRCRAFT ATTITUDE

(71) Applicant: Jeffrey Simon, Sudbury, MA (US)

(72) Inventor: Jeffrey Simon, Sudbury, MA (US)

(73) Assignee: HONEYWELL INTERNATIONAL INC., Morristown, NJ (US)

(21) Appl. No.: 13/453,711

(22) Filed: Apr. 23, 2012

Related U.S. Application Data
(60) Provisional application No. 61/563,253, filed on Nov. 23, 2011.

(51) Int. Cl. G05D 1/08

(52) U.S. Cl. 701/14

(57) ABSTRACT

A system and method for reporting unusual aircraft attitude to a pilot includes sensing aircraft attitude, and processing the sensed aircraft attitude to determine when the aircraft attitude exceeds an attitude limit. A three-dimensional directional audio alert is generated that, when heard by the pilot, sounds like it is coming from a direction to which the pilot should maneuver the aircraft to correct the aircraft attitude, and includes a verbal instruction that the pilot should follow correct the aircraft attitude.

### PRIORITY CLAIMS

This application claims the benefit of U.S. Provisional Application No. 61/563,253 filed Nov. 23, 2011.

### TECHNICAL FIELD

The present invention generally relates to aircraft avionics systems, and more particularly relates to aircraft avionics systems and methods for pre-emptive airspace intrusion warning and status display, three dimensional auditory reporting, and flight plan restarting.

### BACKGROUND

Intrusions into restricted or controlled airspace can be a significant issue for both general and commercial aviation. Although existing navigational aids depict airspace, the 3-dimensional nature of airspace restrictions can make it relatively difficult for a pilot to know whether the path of the aircraft will actually violate the airspace. For example, the aircraft could be flying over or under the controlled portion of the airspace. Current technologies rely on proactive inquiries by the pilot regarding upcoming airspace in order to determine if the aircraft flight path will actually enter the airspace.

In addition, spatial disorientation remains a potential concern. Spatial disorientation can occur when a pilot inadvertently flies from visual meteorological conditions (VMC) into instrument meteorological conditions (IMC) without proper training. Without external visual references, a physiological reaction may occur causing pilot disorientation and discord between a pilot's sense of right-side-up vs. the indications on the aircraft's instruments. In many cases, pilots without proper training will default to their own, potentially incorrect senses rather than relying on the aircraft flight instruments.

Also of concern are very unlikely, yet postulated aircraft incursions. Even when air traffic is called out by approach control or is depicted on a Traffic Collision Avoidance System (TCAS), it can be difficult for a pilot to know where to physically look for the traffic. For example, a pilot may not know how high to look for an aircraft that is 3 miles away and 1,000 feet above his/her current position. If the pilot looks too long in the wrong place, visual fixation may occur resulting in the pilot potentially missing the aircraft, even as it grows closer and larger in the windscreen.

In addition to the above, it is known that deviations from a flight plan can be caused by weather, traffic, or even by the simple act of taking off on a runway heading that is not aligned with the filed course from the origin airport to the first waypoint. Depending on the circumstance, the pilot may want to intercept the existing flight plan course, or simply go directly to the next waypoint in the flight plan. Under such circumstances, approach controllers use the terminology “Cleared as Filed” and “Cleared Direct” to direct the pilot on which of these option to use. The terminology “Cleared as Filed” means that the pilot should direct the aircraft to the original course-line on the active leg of the flight plan, whereas “Cleared Direct” means that the pilot may direct the aircraft from its current position directly to the next waypoint in the flight plan. Current general aviation navigation systems do not offer a direct way of implementing these commands. Either the flight plan remains in place and the pilot needs to manually navigate the aircraft back to the previous course-line, or the pilot has to re-start the flight plan manually from his current position. Neither option is ideal.

Hence, there is a need for systems and methods that makes it relatively intuitive for a pilot to know whether the path of the aircraft will actually violate a controlled airspace and/or systems and methods that alleviate pilot disorientation and/or systems and methods that assist aircraft pilots in determining where to look for external aircraft or other potential incursion objects and/or systems and methods that do not rely on manual flight plan manipulation following a course deviation.

### BRIEF SUMMARY

In one embodiment, a method for reporting unusual aircraft attitude to a pilot includes sensing aircraft attitude, and processing the sensed aircraft attitude to determine when the aircraft attitude exceeds an attitude limit. A three-dimensional directional audio alert is generated that, when heard by the pilot, sounds like its coming from a direction to which the pilot should maneuver the aircraft to correct the aircraft attitude, and includes a verbal instruction that the pilot should follow correct the aircraft attitude.

In another embodiment, a system for reporting unusual aircraft attitude to a pilot includes one or more sensors and a processor. Each sensor is configured to sense aircraft attitude of an aircraft and supply aircraft attitude data representative thereof. The processor is coupled to receive the aircraft attitude data and is configured, in response thereto, to determine aircraft attitude and, when the aircraft attitude exceeds a predetermined attitude limit, generate a three-dimensional directional audio alert that, when heard by the pilot, sounds like its coming from a direction to which the pilot should maneuver the aircraft to correct the aircraft attitude, and includes a verbal instruction that the pilot should follow correct the aircraft attitude.

In yet another embodiment, a system for reporting unusual aircraft attitude to a pilot includes one or more sensors, a display, and a processor. The sensors are each configured to sense aircraft attitude of an aircraft and supply aircraft attitude data representative thereof. The display is coupled to receive image rendering display commands and is configured, in response thereto, to render images thereon. The processor is coupled to receive the aircraft attitude data and is configured, in response thereto, to determine aircraft attitude and, when the aircraft attitude exceeds a predetermined attitude limit, to supply image rendering display commands to the display that cause the display to render a visual alert thereon that comprises one or more arrows indicating the direction the pilot should maneuver the aircraft to correct the aircraft attitude. The processor is also configured to generate a three-dimensional directional audio alert that, when heard by the pilot, sounds like its coming from a direction to which the pilot should maneuver the aircraft to correct the aircraft attitude, includes a verbal instruction that the pilot should follow correct the aircraft attitude, and includes a verbal warning that is representative of the attitude limit.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIGS. 1A and 1B depict an embodiment of a user interface disposed in a portrait and a landscape mode, respectively;

FIG. 2 depicts the user interface of FIGS. 1A and 1B in operable communication with a plurality of exemplary aircraft avionics systems;

FIG. 3 depicts an image of a 2-dimensional map display with dynamically shaded airspace that may be rendered on the user interface depicted in FIGS. 1A and 1B; and

FIG. 4 an image of a plurality of courses that may be rendered on the user interface depicted in FIGS. 1A and 1B.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

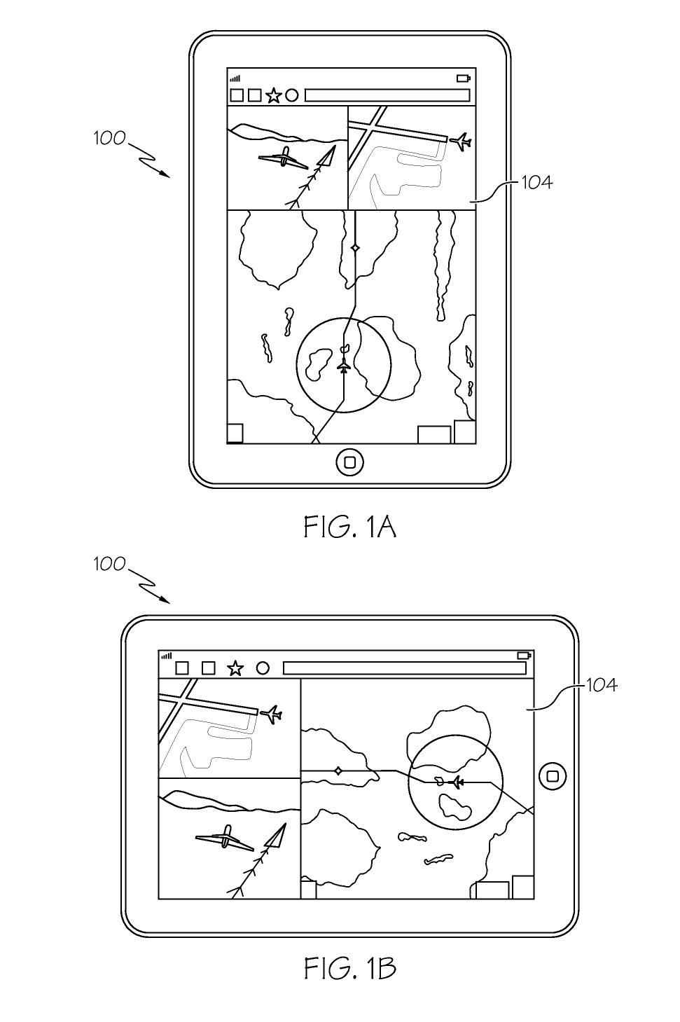

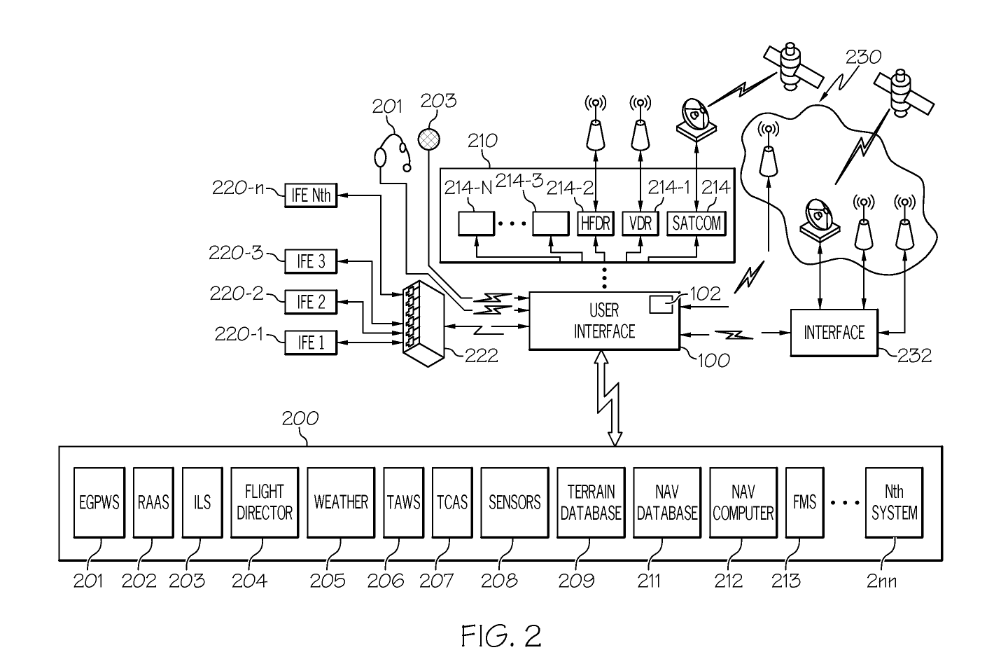

Referring to FIG. 1, a user interface 100 is depicted, disposed in a portrait and a landscape mode, respectively. The user interface 100 is preferably implemented as a hand-held tablet computer device, and may be configured to implement the various functions disclosed herein in a stand-alone manner or in conjunction with various avionics and other systems on-board an aircraft. It will additionally be appreciated that the functions disclosed herein may be implemented in any one of numerous avionics systems that are fixedly installed in aircraft. The user interface 100 thus includes one or more processors 102 (depicted in FIG. 2) and the display 104.

With reference now to FIG. 2, the user interface 100 is depicted in operable communication with a plurality of aircraft avionics systems 200, a plurality of communications systems 210, the in-flight entertainment (IFE) system 220, and a plurality of wireless networks 230. Although the number and type of avionics systems 200 may vary, in the embodiment depicted in FIG. 2, the user interface 100 is in operable communication, via one or more suitable wired communication systems or one or more suitable wireless communications systems, with a plurality of avionics systems. Although these systems may vary, in the depicted embodiment the systems include an enhanced ground proximity warning system (EGPWS) 201, a runway awareness and advisory system (RAAS) 202, an instrument landing system (ILS) 203, a flight director 204, a weather data source 205, a terrain avoidance warning system (TAWS) 206, a traffic and collision avoidance system (TCAS) 207, a plurality of sensors 208 (e.g., a barometric pressure sensor, a thermometer, and a wind speed sensor), one or more terrain databases 209, one or more navigation databases 211, a navigation and control system (or navigation computer) 212, and a flight management system (FMS) 213, just to name a few.

Before proceeding further, it is noted that the above-described avionics systems 200 are merely exemplary of the numerous and varied aircraft avionics systems that may be used to supply various data to, and receive data from, the user interface 100. Thus, FIG. 2 also depicts an additional block labeled “Nth SYSTEM” to denote that additional or other avionics systems may be in communication with the user interface 100. Moreover, while each of the above-mentioned avionics systems is depicted and described as separate physical entities, it will be appreciated that one or more of the functions implemented by these systems may be integrated together into physical entities that may or may not be depicted herein including, as noted above, the user interface 100 itself. Furthermore, one or more of the avionics systems depicted in FIG. 2 may not be needed or desired.

The user interface 100 is also in operable communication with a plurality of communications systems 210 and wireless sub-networks 230. In particular, the user interface 100 is in operable communication with a plurality of radio frequency (RF) (including both HF and VHF) communication devices 214 (e.g., 214-1, 214-2, 214-3 . . . , 214-N) and a satellite communications (SATCOM) communication device 216. It will be appreciated that the number and type of communication devices may vary from system to system and aircraft to aircraft, and that those depicted and described herein are merely exemplary. It will additionally be appreciated that communication with the communications systems 210 may take place via the aircraft communications management unit (CMU), if the aircraft is so equipped.

As FIG. 2 also shows, the user interface 100 is in communication with, or is at least configured to be selectively in communication with, a plurality of wireless sub-networks 230 (e.g., 230-1, 230-2, 230-3 . . . , 230-N). It will be appreciated that the number, types, and functions of the wireless sub-networks 230 may vary. For example, the wireless sub-networks may include various WiFi networks, 3G, 4G, various WiMAX networks, various wireless IP networks, or any other wireless network protocol now known or developed in the future. Moreover, the user interface 100 may be configured to access the wireless sub-networks via any one, or plurality, of suitable devices including USB, Ethernet, or PCMCIA devices, just to name a few. The user interface 100 may interface with all of the wireless sub-networks 230 via one or more internal interfaces, via an external interface 232 or, as FIG. 2 depicts, a combination of both.

The user interface 100 described herein may be configured to implement various pilot aid functions. The user interface 100 may be configured to implement only selected ones or all of the pilot aid functions, various combinations of the pilot aid functions, communications-related functions, or all of these functions. Selected ones of the pilot aid functions will be described herein in turn. Others are described in the attached Appendix.

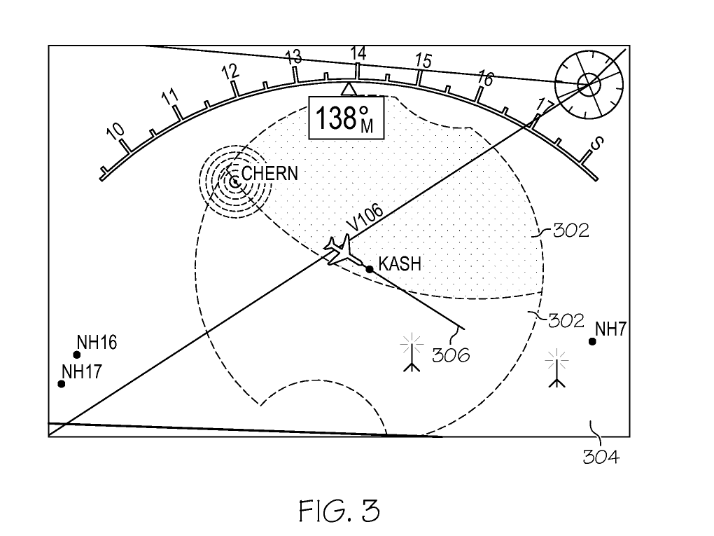

As was noted previously, the 3-dimensional nature of controlled/restricted airspaces can make it relatively difficult for a pilot to know whether the path of the aircraft will actually violate the airspace. This is because the aircraft flight path is typically rendered in a 2-dimensional format. However, as depicted in FIG. 3, the user interface 100 alleviates this issue by dynamically shading airspace on a 2-dimensional map display, based on the current flight trajectory of the aircraft, or on the current flight plan of the aircraft.

The user interface 100 will render controlled/restricted airspace in a plurality of different ways, depending on aircraft position and track. The default rendering of controlled/restricted airspace uses colored, solid, and dashed lines represent the controlled/restricted airspace type. When the current path of the aircraft will take it into a controlled/restricted airspace, it may be progressively shaded, as a warning, and when the aircraft is inside controlled/restricted airspace, the airspace shading is darkest.

More specifically, as the aircraft approaches a controlled/restricted airspace 302, the user interface 100 causes the controlled/restricted airspace 302 to become shaded on the map 304. Moreover, the level of shading may be dependent on aircraft proximity to the controlled/restricted airspace 302. For example, the user interface 100 could render the controlled/restricted airspace 302 25% shaded if the aircraft will enter the airspace 302 within 10 minutes, 50% shaded if it will enter within 5 minutes, and 75% shaded if it is within the controlled/restricted airspace 302. These are merely examples of shading levels and associated times/distances, and other levels and times/distances could be implemented.

As FIG. 3 also depicts, the flight path 306 of the aircraft is extended forward to construct where the aircraft will be at some future point in time to determine if it will enter a controlled/restricted airspace 302. This may be determined using, for example, a 3-dimensional database (e.g., navigation database 208) that includes data representative of controlled/restricted airspaces. Alternatively, the planned flight path of the aircraft is examined to determine if it will enter a controlled/restricted airspace. The 2D depiction of the airspace 302 is then dynamically shaded on the display to indicate the pending intrusion.

Advance notice and graphical depiction of the aircraft trend into restricted or controlled airspace makes recognition of the situation automatic and requires no interaction between the pilot and the navigational display system in order to determine whether a incursion into a controlled/restricted airspace is imminent.

If the aircraft attitude is sensed that exceeds user configurable limits (for example, 30 bank, 15 degrees pitch for more than 5 seconds), the user interface 100 will generate both visual and audio alerts. The aircraft attitudes may be sensed from one of the external avionics systems depicted in FIG. 2 or using on-board sensing systems within the user interface. In either case, the visual alerts may vary and may include arrows indicating the direction for corrective action. The audio alerts are preferably delivered using Stereo and/or 3D directional cues delivered through a headset 201 or speakers 203 via a wireless link. The pilot will sense the audio alerts to be coming from the “proper overhead” position. That is, the audio alert seems to be coming from overhead if the aircraft is straight and level. If the aircraft were in a steep right turn, the audio alert would seem to be coming from the left, etc.

This functionality is implemented using three-dimensional audio rendering, so that the audio alerts regarding unusual aircraft attitudes will appear to come from the “sky” (if the aircraft were in the proper orientation). This provides a more intuitive alert to the pilot as to which way is “up,” so that he pilot may more quickly right the aircraft. In addition, to generating an audio alert such that, when it is heard by the pilot, the alert sounds like it is coming from a direction to which the pilot should maneuver the aircraft to correct the aircraft attitude, the audio alert also includes a verbal instruction that the pilot should follow correct the aircraft attitude. For example, if the aircraft were to exceed a predetermined pitch-down angle, the user interface 100 may supply an audio alert such as “Pull Up!” to the headset 201 or speakers 203. Similarly, if the aircraft were to exceed a predetermined pitch-up angle, the user interface 100 may supply an audio alert such as “Push!, Push!” to the headset 201 or speakers. It will be appreciated that the specific verbal instructions may vary, so long as the instruction clearly conveys the appropriate corrective action to the pilot.

In some embodiments, the verbal instruction may also include a verbal warning that is representative of the attitude limit. For example, if the aircraft were to exceed a predetermined bank angle to the right while descending, the user interface 100 may additionally send one of the following audio alerts to the headset 201 or speakers 203: “Warning—Steep Turn” or “Warning—Overbanking Right.” Moreover, the audio alert would be generated so that it would seem to be coming from over the pilot's left shoulder. The instinctive reaction is to turn towards a sound, which makes it easier for the pilot to recognize that the “sky” is over their left shoulder and they need to correct in that direction.

The user interface 100 may implement any one of numerous techniques to generate the three dimensional audio alerts using either directional speakers or only stereo headsets. The user interface 100 preferably includes limitations for normal flight attitudes. However, when those limits are exceeded, as determined from on-board sensors or, for example, the aircraft Attitude Reference System, the user interface 100 will generate the directional audio alerts.

The user interface 100 may also be configured to generate 3-dimensional audio alerts regarding traffic. These audio alerts will seem to come from the position that the pilot needs to look for the traffic. This also provides a more intuitive alert to the pilot of which way to look quickly. For example, if there is a traffic entity to the right and above the aircraft, the user interface 100 may send one of the following audio alerts to the headset 201 or speakers 203: “Traffic: or “Traffic Two O'Clock High.” This audio alert would seem to come from in front and above the pilot. If the traffic were behind and below, the warning would seem to come from that location, etc. In addition, the attitude of the aircraft could be included in the threat calculation. For example, if the traffic were to the right and at the same altitude, but the aircraft was in a steep descent, the user interface 100 may send one of the following audio alerts to the headset 201 or speakers 203: “Traffic: or “Traffic Two O'Clock Same Altitude.” The audio alert would seem to come from above and to the right of the pilot. The user interface 100 includes specific rules regarding audio alerts, and could be interfaced with any traffic-providing sensor or system.

The aircraft may deviate from the flight plan for any one of several reasons. These include weather, traffic, or even by the simple act of taking off on a runway heading not aligned with the filed flight plan from the origin airport to the first waypoint. Depending on the circumstance, the pilot may want to intercept the existing flight plan course, or simply go direct to the next waypoint in the flight plan. The user interface 100 is configured to allow the pilot to rejoin a flight plan by pressing a button on the flight plan window. If the aircraft is off the flight plan course by greater than 1 NM and presses this button, the pilot will be prompted with two options: “Cleared as Filed” or “Cleared Direct.” If “Cleared as Filed” is selected, an intercept course will be charted to intercept the flight plan leg course line. If “Cleared Direct” is selected, an intercept course will be charted to the next waypoint in the flight plan. The intercept angles/courses can be calculated based on airspeed, preset angles, etc., or be modified dynamically by the pilot.

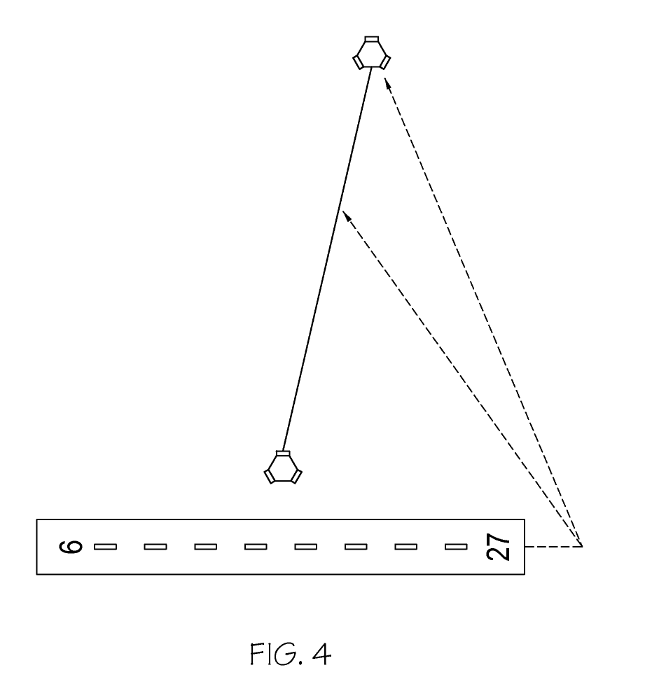

The Cleared as Filed/Cleared Direct functionality allows the pilot to rejoin a flight plan by whichever means is appropriate to the situation. If the user is off the flight plan course by greater than 1 NM (for example), the system could automatically prompt the user with the two options. The user interface 100 may communicate with the aircraft flight management system 213, or its own on-board system. In either case, these can be configured to check for departures from the established flight path, and then present the required options to the pilot. The plotting of the desired courses such as those depicted in FIG. 4, may be easily accomplished using existing flight management technologies.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention.

What is claimed is:

1. A method for reporting unusual aircraft attitude to a pilot, comprising the steps of:
sensing aircraft attitude;
processing the sensed aircraft attitude to determine when the aircraft attitude exceeds an attitude limit; and
generating a three-dimensional directional audio alert that:
(i) when heard by the pilot, sounds like it is coming from a direction to which the pilot should maneuver the aircraft to correct the aircraft attitude, and
(ii) includes a verbal instruction that the pilot should follow correct the aircraft attitude.

2. The method of claim 1, wherein the three-dimensional audio alert further includes a verbal warning that is representative of the attitude limit.

3. The method of claim 1, further comprising:
rendering a visual alert on a display when the aircraft attitude exceeds an attitude limit

4. The method of claim 3, wherein the visual alert comprises one or more arrows indicating the direction the pilot should maneuver the aircraft to correct the aircraft attitude.

5. The method of claim 1, further comprising:
supplying the three-dimensional audio alert to headset having a plurality of earphones.

6. The method of claim 1, further comprising:
supplying the three-dimensional audio alert to an audio speaker.

7. The method of claim 1, further comprising:
wirelessly transmitting the three-dimensional audio alert to a sound generating device.

8. The method of claim 1, wherein the attitude limit is user configurable.

9. A system for reporting unusual aircraft attitude to a pilot, comprising:
one or more sensors configured to sense aircraft attitude of an aircraft and supply aircraft attitude data representative thereof;
a processor coupled to receive the aircraft attitude data and configured, in response thereto, to determine aircraft attitude and, when the aircraft attitude exceeds a predetermined attitude limit, generate a three-dimensional directional audio alert that:
(i) when heard by the pilot, sounds like it is coming from a direction to which the pilot should maneuver the aircraft to correct the aircraft attitude, and
(ii) includes a verbal instruction that the pilot should follow correct the aircraft attitude.

10. The system of claim 9, wherein the processor is further configured to generate the three-dimensional audio alert to further include a verbal warning that is representative of the attitude limit.

11. The system of claim 9, further comprising:
a display coupled to receive image rendering display commands from the processor and configured, in response thereto, to render images thereon,
wherein the processor is further configured to supply image rendering display commands to the display that cause the display to render a visual alert thereon when the aircraft attitude exceeds an attitude limit.

12. The system of claim 11, wherein the visual alert comprises one or more arrows indicating the direction the pilot should maneuver the aircraft to correct the aircraft attitude.

13. The system of claim 9, further comprising:
a headset having a plurality of earphones, the headset in operable communication with the processor to receive the three-dimensional audio alert therefrom.

14. The system of claim 9, further comprising:
to an audio speaker in operable communication with the processor to receive the three-dimensional audio alert therefrom.

15. The system of claim 9, further comprising:
a transmitter in operable communication with the processor to receive the three-dimensional audio alert therefrom, the transmitter configured to wirelessly transmit the three-dimensional audio alert to a sound generating device.

16. The system of claim 9, wherein the attitude limit is user configurable.

17. A system for reporting unusual aircraft attitude to a pilot, comprising:
one or more sensors configured to sense aircraft attitude of an aircraft and supply aircraft attitude data representative thereof;
a display coupled to receive image rendering display commands and configured, in response thereto, to render images thereon; and
a processor coupled to receive the aircraft attitude data and configured, in response thereto, to determine aircraft attitude and, when the aircraft attitude exceeds a predetermined attitude limit, to:
supply image rendering display commands to the display that cause the display to render a visual alert thereon, the visual alert comprising one or more arrows indicating the direction the pilot should maneuver the aircraft to correct the aircraft attitude, and
generate a three-dimensional directional audio alert that:
(i) when heard by the pilot, sounds like it is coming from a direction to which the pilot should maneuver the aircraft to correct the aircraft attitude,
(ii) includes a verbal instruction that the pilot should follow correct the aircraft attitude, and
(iii) includes a verbal warning that is representative of the attitude limit.

18. The system of claim 17, further comprising:
a headset having a plurality of earphones, the headset in operable communication with the processor to receive the three-dimensional audio alert therefrom.

19. The system of claim 17, further comprising:
to an audio speaker in operable communication with the processor to receive the three-dimensional audio alert therefrom.

20. The system of claim 17, further comprising:
a transmitter in operable communication with the processor to receive the three-dimensional audio alert therefrom, the transmitter configured to wirelessly transmit the three-dimensional audio alert to a sound generating device.
